(19) United States
(12) Patent Application Publication
(10) Pub. No.: US 2016/0017167 A1
(43) Pub. Date: Jan. 21, 2016

(54) Scratch Repair Coating

(71) Applicant: Trustor Coatings LLP, Wausau, WI (US)

(72) Inventors: Tryggvi Magnusson, Wausau, WI (US); Guenther Pollak, Mosinee, WI (US)

(21) Appl. No.: 14/801,388

(22) Filed: Jul. 16, 2015

Related U.S. Application Data
(60) Provisional application No. 62/025,263, filed on Jul. 16, 2014.

(51) Int. Cl. C09D 133/00; C09D 7/00; C09D 7/12; B05D 3/06

(52) U.S. Cl. CPC C09D 133/00; B05D 3/067; C09D 7/001; C09D 7/1216; C08K 2003/2227

(57) ABSTRACT

A repair coating for hardwood flooring is provided that effectively repairs scratches in the flooring, but while removing the distinctive white appearance of repairs in flooring having aluminum oxide in the flooring. The coating is formed with an acrylate and a solvent, and can be applied directly to the scratch and cured using UV light, such as sunlight, to fill and repair the scratch in the flooring.

### CROSS-REFERENCE TO RELATED APPLICATIONS

This application claims priority from U.S. Provisional Patent Application Ser. No. 62/025,263, filed on Jul. 16, 2014, the entirety of which is expressly incorporated by reference herein.

### FIELD OF THE INVENTION

The present invention relates generally to a flooring, and more specifically to a coating for use in repairing scratches in flooring.

### BACKGROUND OF THE INVENTION

There are many types of flooring that are formed from hardwood and similar materials. While providing the desired appearance to floors in homes and other environments, flooring made of materials of these types can easily be damaged in any number of ways.

When the damage to the flooring is primarily cosmetic in nature, i.e., is a scratch in the exposed surface of the flooring that does not affect the structural integrity of the flooring material, there are a number of different products available to attempt to repair such scratches. However, when the material forming the flooring is a prefinished material that includes aluminum oxide and/or other minerals, which has a bright white appearance, the repair will show in the form of a white outline or residue around and in the area that was repaired, which can significantly detract from the aesthetics of the flooring.

Thus, it is desirable to develop a repair composition for aluminum oxide flooring that covers and/or eliminates this undesirable white appearance to repaired section of the flooring.

### SUMMARY OF THE INVENTION

Briefly described, one aspect of one exemplary embodiment of the invention provides a repair coating for hardwood flooring that effectively repairs scratches in the flooring, but while removing the distinctive white appearance of repairs in flooring having aluminum oxide and/or other minerals in material forming the flooring. The coating includes an acrylate and a solvent that act to mitigate the appearance of the aluminum oxide, and can be applied directly to the scratch and eared using UV light, such as sunlight or light emitted by artificial light sources, to fill and repair the scratch in the flooring.

Numerous other aspects, features, and advantages of the invention will be made apparent from the following detailed description.

### DETAILED DESCRIPTION OF THE INVENTION

In one exemplary embodiment of the invention, a repair coating is a formulation of a mixture of acrylic oligomers, such as but not limited to urethane, polyester, polyether and epoxy acrylates, and acrylic monomers, such as but not limited to tridipropylene glycol diacrylate (TPGDA), dipropylene glycol diacrylate (DPGDA), 1,6-hexanediol diacrylate (HDDA), trimethylolpropane triacrylate (TMPTA) or cyclic trimethoylpropane acrylate (CFTA), to form an acrylate in association with a solvent and a UV/Photo curing agent. While various suitable acrylates and acrylate mixtures can be used, in an exemplary embodiment an UV curable acrylate is utilized. Further, while a number of solvents are suitable for use in the repair coating, such as water, in an exemplary embodiment an organic solvent, such as but not limited to 1-methoxy-2-propanol, is utilized. Any suitable UV curing agent can be included in the repair coating, as necessary, such as but not limited to Irgacure® 819, Irgacure® 184, Irgacure® 1173 or benzophenone, among others.

The repair coating can include any number of other components, such as water, pigments or any other suitable compounds used in repair coatings, or can be formed exclusively of the acrylate mixture and solvent, optionally in conjunction with the UV curing agent and water.

The amounts of the compounds in the repair composition can vary as necessary, but in one exemplary embodiment the repair coating includes from 50% w/w to 99% w/w of the acrylate and up to 5% w/w of the solvent. In another exemplary embodiment the coating includes from 75% w/w to 99% w/w of the acrylate and up to 4% w/w of the solvent. In still another exemplary embodiment, the coating has approximately 81% w/w of the acrylate and less than 3% w/w of the solvent, with the balance made up of water, UV curing agents and optionally other compounds.

In use, the scratched area of the flooring is initially cleaned and allowed to dry completely. The repair coating is shaken to blend the compounds of the coating within the container for the coating. The repair coating is then applied directly on and into the scratch in order to completely fill the depth of the scratch with the repair coating. Then the coating is wiped into the scratch, such as by using a soft cloth in circular motions, to ensure complete filling of the scratch and to remove any excess coating from around the scratch, as any excess sealer that is not removed may affect the gloss of the repaired area.

Once the scratch is completely filled with the repair coating and all excess repair coating has been removed, the coating is allowed to cure under UV, daylight or artificial light for a period of time, typically less than 10 hours, and more specifically between 4-5 hours. The UV light interacts with the UV curing agent in the repair coating and hardens the repair coating within the scratch.

Various other embodiments of the present invention are contemplated as being within the scope of the filed claims particularly pointing out and distinctly claiming the subject matter regarded as the invention.

1. An aluminum oxide-containing flooring repair coating composition comprising:
a) acrylate; and
b) a solvent.

2. The coating composition of claim 1 wherein the acrylate comprises a mixture of an acrylate oligomer and an acrylate monomer.

3. The coating composition of claim 2 wherein the acrylate oligomer is selected from the group consisting of: urethane acrylates, polyester acrylates, polyether acrylates, epoxy acrylates and combinations thereof.

4. The coating composition of claim 2 wherein the acrylate monomer is selected from the group consisting of: TPGDA, DPGDA, HDDA, TMPTA, and CTFA.

5. The coating composition of claim 1 further comprising a UV curing agent.

6. The coating composition of claim 5 wherein the UV curing agent is selected from the group consisting of Irgacure® 819, Irgacure® 184, Irgacure® 1173 and benzophenone.

7. The coating composition of claim 1 wherein the solvent is an organic solvent.

8. The coating composition of claim 7 wherein the organic solvent is 1-methoxy-2-propanol.

9. The coating composition of claim 1 comprising:
a) 75% w/w to 99% w/w of the acrylate; and
b) up to 4% w/w of the solvent.

10. The coating composition of claim 9 comprising:
a) approximately 81% w/w of the acrylate;
b) less than 3% w/w of the solvent and;
c) the balance made up of other optional compounds.

11. The coating composition of claim 11 wherein the other optional compounds are selected from the group consisting of water, pigments, UV curing agents, and combinations thereof.

12. The coating composition of claim 9 further comprising a UV curing agent wherein the coating composition comprises:
a) 50%-99% w/w of the acrylate; and
b) up to 49% w/w of the solvent.
c) up to 5% w/w of the UV curing agent.

13. A method of repairing flooring including aluminum oxide, the method comprising the steps of:
a) providing the coating composition of claim 1;
b) applying the coating composition to a scratch in the flooring.

14. A flooring repair coating composition consisting of:
a) an acrylate formed of a mixture of an acrylate oligomer and an acrylate monomer; and
b) a solvent.

15. The coating composition of claim 14 wherein the acrylate oligomer is selected from the group consisting of: urethane acrylates, polyester acrylates, polyether acrylates, epoxy acrylates and combinations thereof.

16. The coating composition of claim 14 wherein the acrylate monomer is selected from the group consisting of: TPGDA, DPGDA, HDDA, TMPTA, and CTFA.

17. The coating composition of claim 14 further comprising a UV curing agent.

18. The coating composition of claim 17 wherein the solvent is an organic solvent.

19. The coating composition of claim 18 wherein the organic solvent is 1-methoxy-2-propanol.
